(19) United States
(12) Patent Application Publication
(10) Pub. No.: US 2002/0083001 A1
(43) Pub. Date: Jun. 27, 2002

(54) Image forming apparatus, enciphered data processing method and enciphered data processing system

(76) Inventor: Noriaki Ogishima, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/022,773

(22) Filed: Dec. 20, 2001

(30) Foreign Application Priority Data
Dec. 22, 2000 (JP) 2000-391242
Dec. 13, 2001 (JP) 2001-380452

(51) Int. Cl. H04K 1/00; H04L 9/00; G06F 17/60

(52) U.S. Cl. 705/51

(57) ABSTRACT

An image forming apparatus includes a deciphering section for receiving and deciphering enciphered data, and a printing section for printing enciphered data on a recording medium. The image forming apparatus may be provided with a processing section for updating software or updating a version of a program based on the deciphered data.

### BACKGROUND OF THE INVENTION

This application claims the benefit of Japanese Patent Applications No. 2000-391242 filed Dec. 22, 2000 and No. 2001-380452 filed Dec. 13, 2001, in the Japanese Patent Office, the disclosure of which is hereby incorporated by reference.

1. Field of the Invention

The present invention generally relates to image forming apparatuses, enciphered data processing methods and enciphered data processing systems, and more particularly to an image forming apparatus, an enciphered data processing system and an enciphered data processing system for preventing copying of distributed data when digital contents are distributed.

2. Description of the Related Art

Conventionally, pay-services or free services are provided to distribute various kinds of digital data via networks. The various kinds of digital data include character information, image data, audio data, and data for updating software or updating versions of programs used in various apparatuses.

FIG. 1 is a diagram showing an example of a conventional digital data distribution system. The digital data distribution system shown in FIG. 1 includes a client terminal equipment 1 which is formed by a personal computer (PC) or the like, a printing apparatus 3 connected to the terminal equipment 1, and a server 2 which is accessible from the terminal equipment 1 via a network 4 such as the Internet. The server 2 forms a provider which provides the digital contents, and transfers the digital data to the terminal equipment 1 via the network 4 in response to a request from the terminal equipment 1. The terminal equipment 1 downloads the digital data transferred from the server 2, and can display the downloaded digital data on a display unit or print the downloaded digital data on the printing apparatus 3. In addition, the terminal equipment 1 can edit the downloaded digital on the display unit, and print the edited digital data on the printing apparatus 3.

However, the digital data can easily be copied. In addition, when distributing the digital data by the pay-service, it is necessary to prevent easy copying of the digital data, particularly when the digital data are copyrighted. For this reason, various enciphering systems have been proposed to prevent copying of the digital data, by enciphering the digital data before transmission at the transmitting end and deciphering the enciphered digital data at the receiving end.

FIG. 2 is a diagram showing an example of a conventional digital data distribution system which employs an enciphering system. In FIG. 2, those parts which are the same as those corresponding parts in FIG. 1 are designated by the same reference numerals, and a description thereof will be omitted.

In the case of the digital data distribution system shown in FIG. 2, the server 2 transfers enciphered digital data to the terminal equipment 1 via the network 4 in response to a request from the terminal equipment 1. The terminal equipment 1 downloads the enciphered digital data transferred from the server 2, and deciphers the enciphered digital data back to the original digital data which may be displayed on the display unit or printed on the printing apparatus 3. In addition, the terminal equipment 1 can edit the deciphered digital on the display unit, and print the edited digital data on the printing apparatus 3.

However, although the digital data transferred from the server 2 to the terminal equipment 1 are in the enciphered form when transferred via the network 4, the digital data can easily be copied after being deciphered in the terminal equipment 1. In other words, there were problems in that the enciphered digital data after being deciphered in the terminal equipment 1 can be copied to a storage medium by a third party or a user of the terminal equipment 1 or, the deciphered digital data may be transferred to another terminal equipment and copied by a third party or a user of this other terminal equipment. In addition, when transferring the deciphered digital data from the terminal equipment 1 to another terminal equipment, there was a problem in that the deciphered digital data can easily be copied by a third party particularly when the deciphered digital data are transferred from the terminal equipment 1 to the other terminal equipment via a network or the like.

Furthermore, when transferring the deciphered digital data from the terminal equipment 1 to the printing apparatus 3, there was a problem in that the deciphered digital data can easily be copied by a third party particularly when the deciphered digital data are transferred from the terminal equipment 1 to the printing apparatus 3 via a network or the like.

The problems described above are not limited to cases where the digital data are distributed via cable networks, but also occur in cases where the digital data are distributed via radio or wireless networks.

### SUMMARY OF THE INVENTION

Accordingly, it is a general object of the present invention to provide a novel and useful image forming apparatus, enciphered data processing method and enciphered data processing system, in which the problems described above are eliminated.

Another and more specific object of the present invention is to provide an image forming apparatus, enciphered data processing method and enciphered data processing system, which can prevent copying of digital data which are distributed via networks, when distributing digital data which are copyrighted and/or an accounting process with respect to the digital data distribution is desired or necessary.

Still another object of the present invention is to provide an image forming apparatus comprising deciphering means for receiving and deciphering enciphered data, and printing means for printing enciphered data on a recording medium. According to the image forming apparatus of the present invention, it is possible to prevent copying of digital data which are distributed via networks, when distributing digital data which are copyrighted and/or an accounting process with respect to the digital data distribution is desired or necessary.

A further object of the present invention is to provide an image forming apparatus comprising deciphering means for receiving and deciphering enciphered data, processing means for updating software or updating a version of a program based on deciphered data, and printing means for printing data on a recording medium. According to the image forming apparatus of the present invention, it is possible to prevent copying of digital data which are distributed via networks, when distributing digital data which are copyrighted and/or an accounting process with respect to the digital data distribution is desired or necessary. In addition, it is possible to update the software or the version of the program.

The image forming apparatus may further comprise request generating means for requesting the enciphered data with respect to an external server.

The image forming apparatus may further comprise key generating means for generating an enciphering key for use in an enciphering process carried out in an external server which provides the enciphered data. In the image forming apparatus, the key generating means may generate the enciphering key based on information peculiar to the image forming apparatus. Or, in the image forming apparatus, the key generating means may generate the enciphering key based on information peculiar to the image forming apparatus and a random variable. The use of the enciphering key makes it possible to more positively prevent copying of the digital data.

Another object of the present invention is to provide an enciphered data processing method comprising a requesting step requesting data with respect to a server, a transmitting step enciphering requested data in the server and transmitting enciphered data via a network, a deciphering step receiving and deciphering the enciphered data in an apparatus which at least has a printing function, and a printing step printing deciphered data on a recording medium in the apparatus. According to the enciphered data processing method of the present invention, it is possible to prevent copying of digital data which are distributed via networks, when distributing digital data which are copyrighted and/or an accounting process with respect to the digital data distribution is desired or necessary.

Still another object of the present invention is to provide an enciphered data processing method comprising a requesting step requesting data with respect to a server, a transmitting step enciphering requested data in the server and transmitting enciphered data via a network, a deciphering step receiving and deciphering the enciphered data in an apparatus which at least has a printing function, and a processing step updating software or updating a version of a program based on deciphered data. According to the enciphered data processing method of the present invention, it is possible to prevent copying of digital data which are distributed via networks, when distributing digital data which are copyrighted and/or an accounting process with respect to the digital data distribution is desired or necessary. In addition, it is possible to update the software or the version of the program.

The enciphered data processing method may further comprise a request generating step requesting the enciphered data with respect to an external server.

In the enciphered data processing method, the request generating step may generate the request from a terminal equipment which is coupled to the apparatus and is capable of accessing the server.

In the enciphered data processing method, the request generating step may generate the request from the apparatus which is capable of accessing the server.

The enciphered data processing method may further comprise a key generating step generating an enciphering key which is used by the transmitting step, in the apparatus. In the enciphered data processing method, the key generating step may generate the enciphering key based on information peculiar to the apparatus. Or, in the enciphered data processing method, the key generating step may generate the enciphering key based on information peculiar to the apparatus and a random variable. The use of the enciphering key makes it possible to more positively prevent copying of the digital data.

A further object of the present invention is to provide an enciphered data processing system comprising request means for requesting data with respect to a server, transmitting means for enciphering requested data in the server and transmitting enciphered data via a network, deciphering means for receiving and deciphering the enciphered data in an apparatus which at least has a printing function, and printing means for printing deciphered data on a recording medium in the apparatus. According to the enciphered data processing system of the present invention, it is possible to prevent copying of digital data which are distributed via networks, when distributing digital data which are copyrighted and/or an accounting process with respect to the digital data distribution is desired or necessary.

Still another object of the present invention is to provide an enciphered data processing system comprising requesting means for requesting data with respect to a server, transmitting means for enciphering requested data in the server and transmitting enciphered data via a network, deciphering means for receiving and deciphering the enciphered data in an apparatus which at least has a printing function, and processing means for updating software or updating a version of a program in the apparatus based on deciphered data. According to the enciphered data processing system of the present invention, it is possible to prevent copying of digital data which are distributed via networks, when distributing digital data which are copyrighted and/or an accounting process with respect to the digital data distribution is desired or necessary. In addition, it is possible to update the software or the version of the program.

In the enciphered data processing system, the requesting means may be provided in a terminal equipment which is coupled to the apparatus and is capable of accessing the server.

In the enciphered data processing system, the requesting means may be provided in the apparatus which is capable of accessing the server.

The enciphered data processing system may further comprise key generating means for generating an enciphering key which is used by the transmitting means, in the apparatus. The use of the enciphering key makes it possible to more positively prevent copying of the digital data.

Other objects and further features of the present invention will be apparent from the following detailed description when read in conjunction with the accompanying drawings.

### BRIEF DESCRIPTION OF THE DRAWINGS

FIG. 1 is a diagram showing an example of a conventional digital data distribution system;

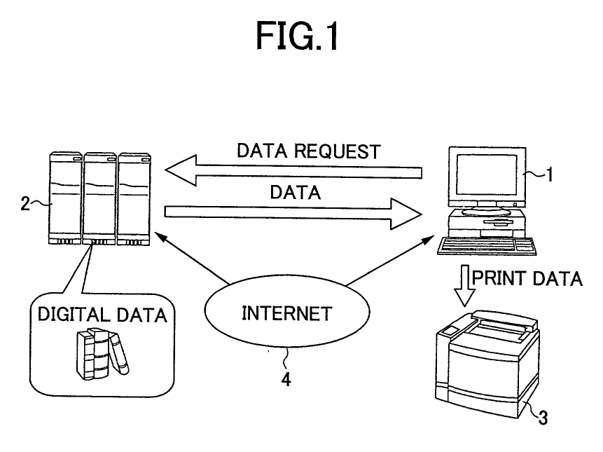

FIG. 2 is a diagram showing an example of a conventional digital data distribution system which employs an enciphering system;

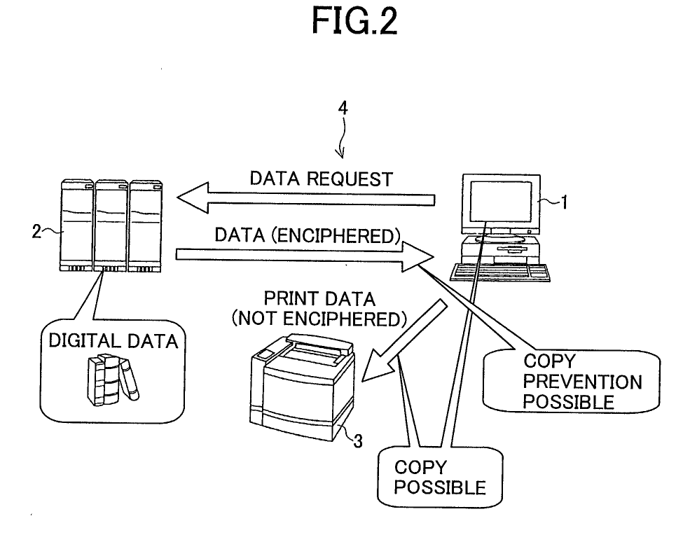

FIG. 3 is a diagram showing a digital data distribution system which is applied with a first embodiment of an enciphered data processing method according to the present invention;

FIG. 4 is a system block diagram showing a basic structure of an important part of a server;

FIG. 5 is a system block diagram showing a basic structure of an important part of a terminal equipment;

FIG. 6 is a system block diagram showing a basic structure of an important part of a printing apparatus;

FIG. 7 is a diagram showing a digital data distribution system which is applied with a second embodiment of the enciphered data processing method according to the present invention;

FIG. 8 is a diagram showing a digital data distribution system which is applied with a third embodiment of the enciphered data processing method according to the present invention;

FIG. 9 is a diagram for explaining generation of an enciphering key using a random variable;

FIG. 10 is a diagram for explaining an enciphering process;

FIG. 11 is a flow chart for explaining an embodiment of the operation of an enciphered data processing system in the third embodiment;

FIG. 12 is a flow chart for explaining another embodiment of the operation of the enciphered data processing system in the third embodiment;

FIG. 13 is a diagram showing a digital data distribution system which is applied with a fourth embodiment of the enciphered data processing method according to the present invention;

FIG. 14 is a system block diagram showing a basic structure of an important part of a composite apparatus;

FIG. 15 is a diagram for explaining an embodiment of a software structure of the composite apparatus;

FIG. 16 is a flow chart for explaining an embodiment of the operation of the enciphered data processing system in the fourth embodiment;

FIG. 17 is a diagram for explaining a menu displayed on an operation section; and

FIG. 18 is a flow chart for explaining another embodiment of the operation of the enciphered data processing system in the fourth embodiment.

### DESCRIPTION OF THE PREFERRED EMBODIMENTS

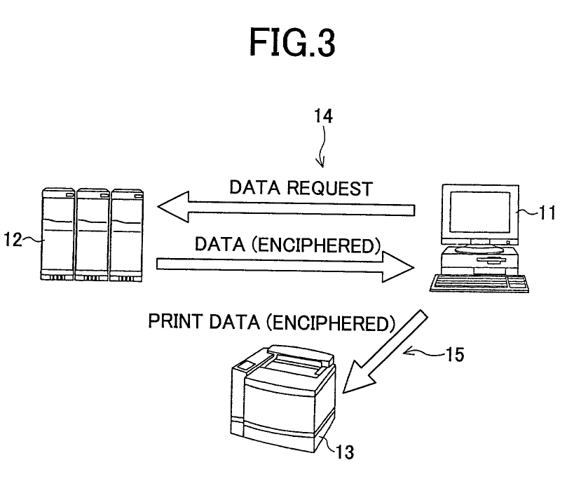

A description will be given of embodiments of an image forming apparatus according to the present invention, an enciphered data processing method according to the present invention and an enciphered data processing system according to the present invention, by referring to FIG. 3 and the subsequent drawings.

FIG. 3 is a diagram showing a digital data distribution system which is applied with a first embodiment of the enciphered data processing method according to the present invention. The digital data distribution system shown in FIG. 3 corresponds to a first embodiment of an enciphered data processing system according to the present invention. The digital data distribution system includes a client terminal equipment 11 such as a personal computer (PC), a printing apparatus 13 which is connected to the terminal equipment 11 via a network 15, and a server 12 which is accessible from the terminal equipment 11 via a network 14 such as the Internet. The network 14 connecting the terminal equipment 11 and the server 1 may be a cable network, a radio or wireless network or, a combination of a cable network and a radio or wireless network. This first embodiment of the enciphered data processing method and this first embodiment of the enciphered data processing system employs a first embodiment of the image forming apparatus according to the present invention. The printing apparatus 13 corresponds to this first embodiment of the image forming apparatus.

The server 12 forms a provider which provides digital contents. The server 12 transfers digital data to the terminal equipment 11 via the network 14 in response to a request from the terminal equipment 11.

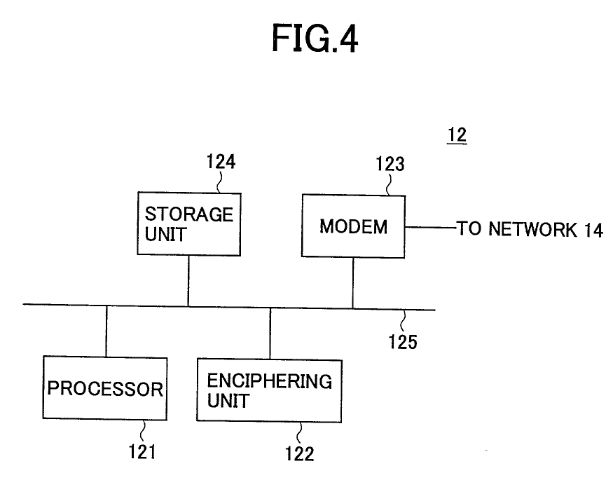

FIG. 4 is a system block diagram showing a basic structure of an important part of the server 12. As shown in FIG. 4, the server 12 includes a processor 121, an enciphering unit 122, a modem 123 and a storage unit 124 which are connected via a bus 125. The processor 121 is formed by a CPU or the like, and controls the general operation of the server 12. The enciphering unit 122 enciphers the digital data and the like which are to be transferred in conformance with an arbitrary enciphering system. The modem 123 transmits the enciphered digital data and the like to the network 14, and receives data, requests and the like via the network 14. The storage unit 124 stores the digital data of the digital contents and the like, and various data such as intermediate results of operations carried out by the processor 121. The storage unit 124 is formed by a storage apparatus which uses a recording medium such as a magnetic recording medium, an optical recording medium and a magneto-optical recording medium, a semiconductor memory device such as a RAM and a ROM, or the like.

The basic structure of the server 12 is not limited to that shown in FIG. 4, and a general purpose computer may be used for the server 12 as long as the general purpose computer is provided with a function of enciphering the digital data and the like which are to be transferred. In addition, the enciphering unit 122 may be omitted if the processor 121 is constructed to carry out the enciphering process.

The terminal equipment 11 requests desired digital contents to the server 12, receives the requested digital contents from the server 12, and transfers the received digital contents to the printing apparatus 13.

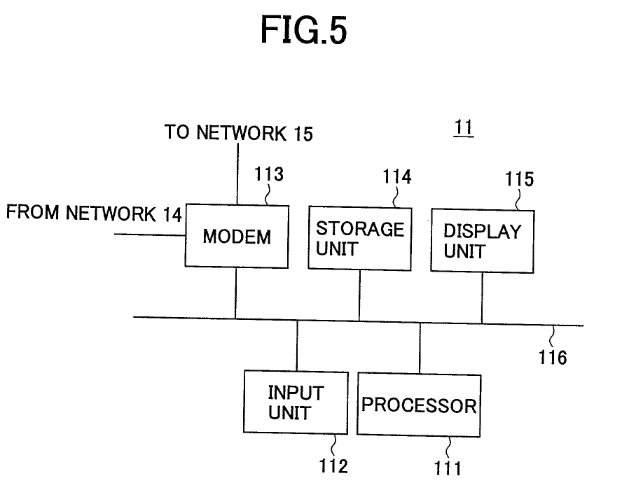

FIG. 5 is a system block diagram showing a basic structure of an important part of the terminal equipment 11. As shown in FIG. 5, the terminal equipment 11 includes a processor 111, an input unit 112, a modem 113, a storage unit 114, and a display unit 115 which are connected via a bus 116. The processor 111 is formed by a CPU or the like, and controls the general operation of the terminal equipment 11. The input unit 112 is formed by a keyboard or the like and is used to input data and instructions to the processor 111. The modem 113 receives the enciphered digital data and the like from the server 12 via the network 14, and transmits data, requests and the like via the network 14. In addition, the modem 113 transmits the enciphered digital data, instructions and the like to the printing apparatus 13 via the network 15, and receives data, requests and the like from the printing apparatus 13 via the network 15. The storage unit 114 stores various data, including the enciphered digital which are received via the network 14 and downloaded, the data received via the network 15, and intermediate results of operations carried out by the processor 111. The storage unit 114 is formed by a storage apparatus which uses a recording medium such as a magnetic recording medium, an optical recording medium and a magneto-optical recording medium, a semiconductor memory device such as a RAM and a ROM, or the like. The display unit 115 is used to display various data.

In this embodiment, the terminal equipment 11 is not provided with a means for deciphering the enciphered digital data and the like, and is constructed to simply transfer the enciphered digital data and the like as they are to the printing apparatus 13. Accordingly, the enciphered digital data and the like from the server 12 cannot be deciphered and displayed on the display unit 115. For this reason, the digital data and the like provided by the server 12 cannot be copied at the terminal equipment 11.

While the terminal equipment 11 is transferring the enciphered digital data and the like to the printing apparatus 13, it is possible to display a message or the like on the display unit 115 to indicate the transfer, for example, so as to enable the user to confirm that the requested digital data and the like are being received.

The basic structure of the terminal equipment 11 is not limited to that shown in FIG. 5, and a general purpose personal computer or a portable terminal equipment such as a mobile telephone may be used for the terminal equipment 11 as long as the general purpose personal computer or the portable terminal equipment is provided with a function of requesting the desired digital contents or the like to the server 12, downloading the enciphered digital data and the like transferred from the server 12, and transferring the enciphered digital data and the like as they are to the printing apparatus 13. In other words, if the server 12 is a Web server, the terminal equipment 11 may be provided with a Web browser in order to request the desired digital contents or the like to the server 12 and download the enciphered digital data and the like transferred from the server 12.

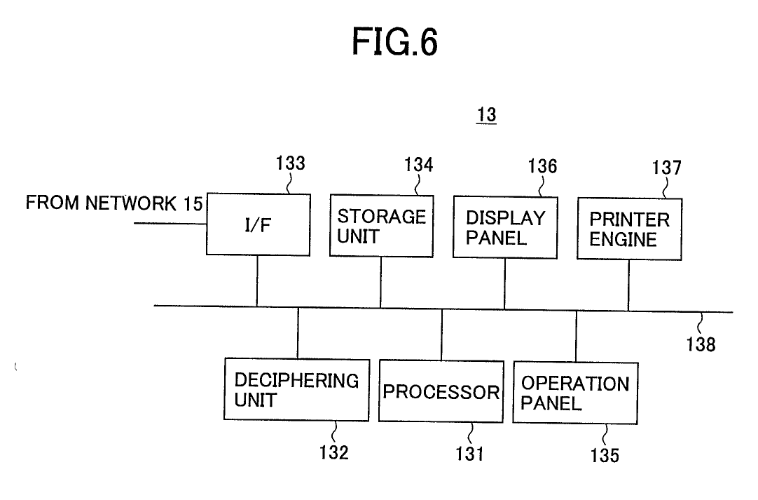

FIG. 6 is a system block diagram showing a basic structure of an important part of the printing apparatus 13. As shown in FIG. 6, the printing apparatus 13 includes a processor 131, a deciphering unit 132, an interface (I/F) 133, a storage unit 134, an operation panel 135, a display panel 136, and a printer engine 137 which are connected via a bus 138. The processor 131 is formed by a CPU or the like, and controls the general operation of the printing apparatus 13. The deciphering unit 132 reads the enciphered digital data and the like from the storage unit 134 which will be described later, and deciphers the enciphered digital data and the like based on the enciphering system used by the enciphering unit 122 of the server 12. The interface 133 receives the enciphered digital data and the like from the terminal equipment 11 via the network 15, and transmits data, requests and the like via the network 15. The storage unit 134 stores various data including the enciphered digital data which are received via the network 15 and downloaded, and intermediate results of operations carried out by the processor 131. The storage unit 134 is formed by a storage apparatus which uses a recording medium such as a magnetic recording medium, an optical recording medium and a magneto-optical recording medium, a semiconductor memory device such as a RAM and a ROM, or the, like. The operation panel 135 is formed by keys, buttons or the like which are used to input instructions and the like to the processor 131. The display panel 136 is used to display various data such as an operation state of the printing apparatus 13. The printer engine 137 prints various data such as the original digital data and the like which are deciphered, onto a recording medium such as paper, by a known printing system such as the electrophotography system and the ink-jet system.

For example, the operation panel 135 and the display panel 136 may be formed integrally by use of a touch-panel or the like. In this case, it is unnecessary to independently provide the operation panel 135 and the display panel 136.

The basic structure of the printing apparatus 13 is not limited to that shown in FIG. 6, and printing apparatuses employing various printing systems may be used for the printing apparatus 31 as long as the printing apparatus is provided with a function of deciphering the encoded digital data and the like.

The deciphering unit 132 deciphers the enciphered digital data and the like which are received via the terminal equipment 11 based on the enciphering system used by the enciphering unit 122 of the server 12, so as to obtain the original digital data and the like. In other words, because the enciphered digital data and the like are deciphered in the printing apparatus 13, it is extremely difficult to easily copy the digital data and the like provided by the server 12.

In a case where the deciphered digital data and the like include character information and image data, the printing apparatus 13 can print the deciphered character information, image data and the like by the printer engine 137. On the other hand, in a case where the deciphered digital data and the like include data for updating software or updating versions of programs used by the printing apparatus 13, the processor 131 can update the software stored in the storage unit 134 or update the version of the program stored in the storage unit 134, by a known method, using the data for updating software or updating versions of programs.

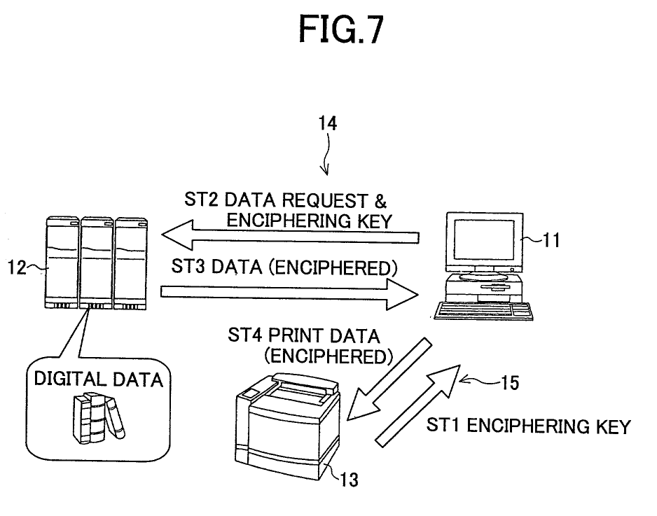

Next, a description will be given of a second embodiment of the image forming apparatus according to the present invention, a second embodiment of the enciphered data processing method according to the present invention, and a second embodiment of the enciphered data processing system according to the present invention. FIG. 7 is a diagram showing a digital data distribution system which is applied with the second embodiment of the enciphered data processing method. In FIG. 7, those parts which are the same as those corresponding parts in FIG. 3 are designated by the same reference numerals, and a description thereof will be omitted.

The digital data distribution system shown in FIG. 7 corresponds to the second embodiment of the enciphered data processing system according to the present invention. The second embodiment of the enciphered data processing method and the second embodiment of the enciphered data processing system employ the second embodiment of the image forming apparatus according to the present invention. The printing apparatus 13 corresponds to the second embodiment of the image forming apparatus. This embodiment uses an enciphering key peculiar to the printing apparatus 13. For example, a manufacturer's part number or an Internet protocol (IP) address of the printing apparatus 13 may be used as the enciphering key peculiar to the printing apparatus 13. In the following description, the enciphering key peculiar to the printing apparatus 13 will also be referred to as a machine-specified key.

When an access is made from the terminal equipment 11 to a home page or the like provided by the server 12, the server 12 requests to the terminal equipment 11 an enciphering key for use in enciphering the digital data and the like which are to be distributed. The terminal equipment 11 transfers the enciphering key request from the server 12 to the printing apparatus 13, and acquires the enciphering key from the printing apparatus 13 in a step ST1 shown in FIG. 7. The terminal equipment 11 transfers to the server 12 the acquired enciphering key and a request for the contents the user wishes to acquire in a step ST2. The enciphering key is stored in the storage unit 134 of the printing apparatus 13. The server 12 enciphers the digital data and the like of the requested contents by the enciphering unit 122 using the enciphering key which is transferred from the terminal equipment 11, and transfers the enciphered digital data and the like to the terminal equipment 11 in a step ST3. The enciphered digital data and the like transferred to the terminal equipment 11 are transferred to the printing apparatus 13. The printing apparatus 13 deciphers the enciphered digital data and the like transferred from the terminal equipment 11 by the deciphering unit 132 using the enciphering key, so as to decipher the enciphered digital data and the like to the original digital data and the like. When printing the deciphered digital data and the like, the printing apparatus 13 prints the digital data and the like on a recording medium by the printer engine 137 in a step ST4.

In this embodiment, the digital data and the like are enciphered using the enciphering key which is peculiar to the printing apparatus 13. The enciphered digital data and the like are deciphered in the printing apparatus 13 using this enciphering key. Because the enciphering key differs for each printing apparatus 13, it becomes further difficult to easily copy the digital data and the like provided by the server 12.

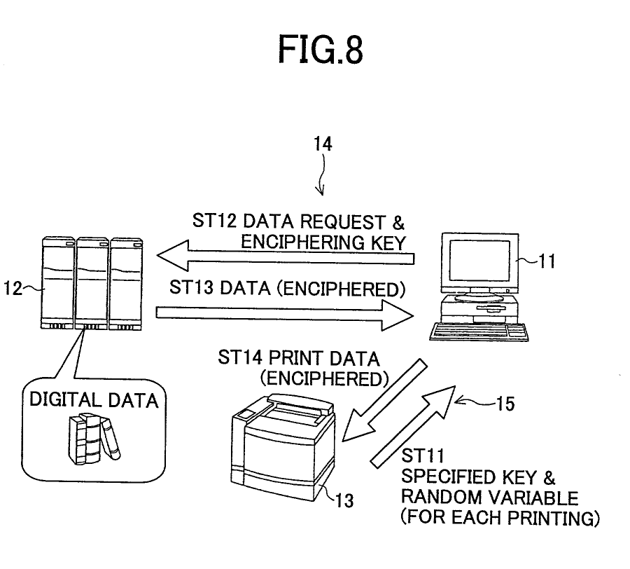

Next, a description will be given of a third embodiment of the image forming apparatus according to the present invention, a third embodiment of the enciphered data processing method according to the present invention, and a third embodiment of the enciphered data processing system according to the present invention. FIG. 8 is a diagram showing a digital data distribution system which is applied with the third embodiment of the enciphered data processing method according to the present invention. In FIG. 8, those parts which are the same as those corresponding part in FIG. 3 are designated by the same reference numerals, and a description thereof will be omitted.

The digital data distribution system shown in FIG. 8 corresponds to,the third embodiment of the enciphered data processing system according to the present invention. The third embodiment of the enciphered data processing method and the third embodiment of the enciphered data processing system employ the third embodiment of the image forming apparatus according to the present invention. The printing apparatus 13 corresponds to the third embodiment of the image forming apparatus. This embodiment uses an enciphering key which is generated by a combination of an enciphering key peculiar to the printing apparatus 13 and a random variable. For example, a manufacturer's part number or an Internet protocol (IP) address of the printing apparatus 13 may be used as the enciphering key peculiar to the printing apparatus 13. In the following description, the enciphering key peculiar to the printing apparatus 13 will also be referred to as a machine-specified key. The random variable may be generated by the processor 131 of the printing apparatus 13 or, generated by an exclusive random variable generator (not shown) which is provided in the printing apparatus 13. As is well known, the printing apparatus 13 manages, by an internal or external counter (not shown) or the like, parameters such as the present time and the total number of prints made, in order to manage the maintenance and replacement intervals of parts within the printing apparatus 13. Accordingly, the random variable may be generated based on the parameters such as the present time and the total number of prints made.

When an access is made from the terminal equipment 11 to a home page or the like provided by the server 12, the server 12 requests to the terminal equipment 11 an enciphering key for use in enciphering the digital data and the like which are to be distributed. The terminal equipment 11 transfers the enciphering key request from the server 12 to the printing apparatus 13, and acquires the enciphering key from the printing apparatus 13 in a step ST11 shown in FIG. 8. The terminal equipment 11 transfers to the server 12 the acquired enciphering key and a request for the contents the user wishes to acquire in a step ST12. The enciphering key is generated based on the random variable which is generated and the machine-specified key which is stored in the storage unit 134 of the printing apparatus 13, and the generated enciphering key is stored in the storage unit 134. The server 12 enciphers the digital data and the like of the requested contents by the enciphering unit 122 using the enciphering key which is transferred from the terminal equipment 11, and transfers the enciphered digital data and the like to the terminal equipment 11 in a step ST13. The enciphered digital data and the like transferred to the terminal equipment 11 are transferred to the printing apparatus 13. The printing apparatus 13 deciphers the enciphered digital data and the like transferred from the terminal equipment 11 by the deciphering unit 132 using the enciphering key which was generated and stored in the storage unit 134 as described above, so as to decipher the enciphered digital data and the like to the original digital data and the like. When printing the deciphered digital data and the like, the printing apparatus 13 prints the digital data and the like on a recording medium by the printer engine 137 in a step ST14.

In this embodiment, the digital data and the like are enciphered using the enciphering key which is generated based on the machine-specified key and the random variable. The enciphered digital data and the like are deciphered in the printing apparatus 13 using this enciphering key. Because the enciphering key differs for each printing apparatus 13 and also differs depending on the random variable which is generated within the printing apparatus 13, it becomes even further difficult to easily copy the digital data and the like provided by the server 12.

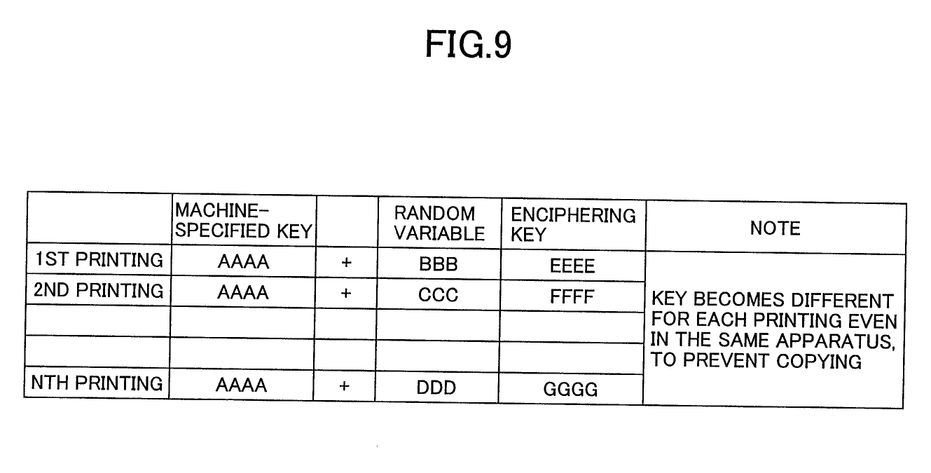

FIG. 9 is a diagram for explaining generation of an enciphering key using the random variable. FIG. 9 shows a case where the machine-specified key of the printing apparatus 13 is “AAAA”. In response to a first print (request), an enciphering key EEEE is generated based on the machine-specified key AAAA and a random variable BBB which is generated based on the above described parameter. In response to a second print (request), an enciphering key FFFF is generated based on the machine-specified key AAAA and a random variable CCC which is generated based on the above described parameter. Similarly, in response to an Nth print (request), an enciphering key GGGG is generated based on the machine-specified key AAAA and a random variable DDD which is generated based on the above described parameter.

As may be seen from FIG. 9, the random variable which is generated every time the print (request) is made is different each time even in the case of the same printing apparatus 13, and thus, the enciphering key accordingly becomes different every time the print (request) is made. The enciphered digital data and the like transferred from the server 12 to the printing apparatus 13 are enciphered using this enciphering key, and the deciphering process with respect to the enciphered digital data and the like is carried out within the printing apparatus 13. For this reason, it becomes even further difficult for a third party or the user of the printing apparatus 13 to easily copy the digital data and the like provided by the server 12.

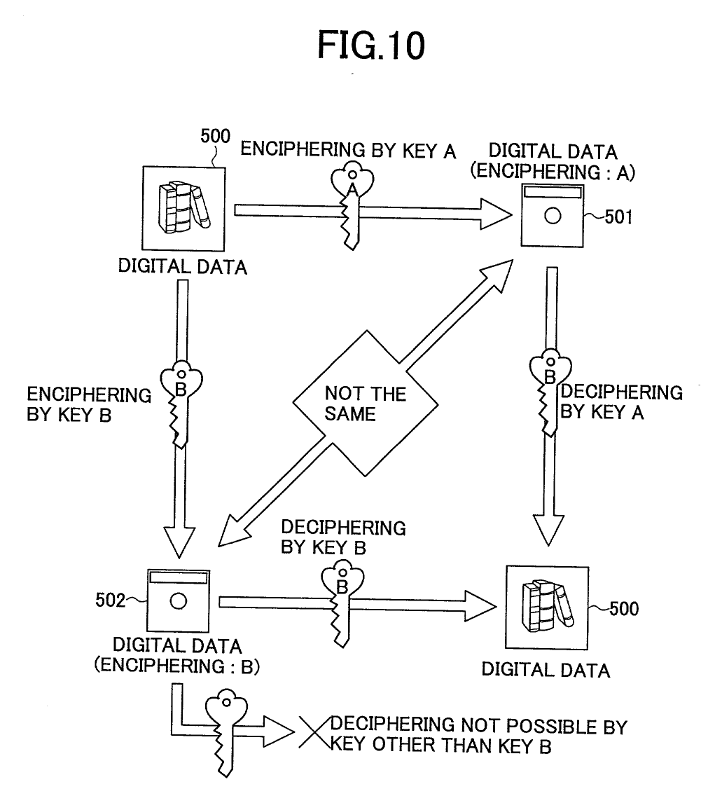

FIG. 10 is a diagram for explaining the enciphering process. As shown in FIG. 10, enciphered digital data 501 which are obtained by enciphering digital data 500 by using an enciphering key A, are different from enciphered digital data 502 which are obtained by enciphering the same digital data 500 by using an enciphering key B. The enciphered digital data 501 can only be deciphered back to the original digital data 500 by use of the enciphering key A. Similarly, the enciphered digital data 502 can only be deciphered back to the original digital data 500 by use of the enciphering key B. As shown in FIG. 10, the enciphered digital data 502 cannot be deciphered back to the original digital data 500 by use of an enciphering key other than the enciphering key B. Accordingly, it becomes extremely difficult for a third party or the user of the printing apparatus 13 to easily copy the deciphered original digital data and the like, as described above.

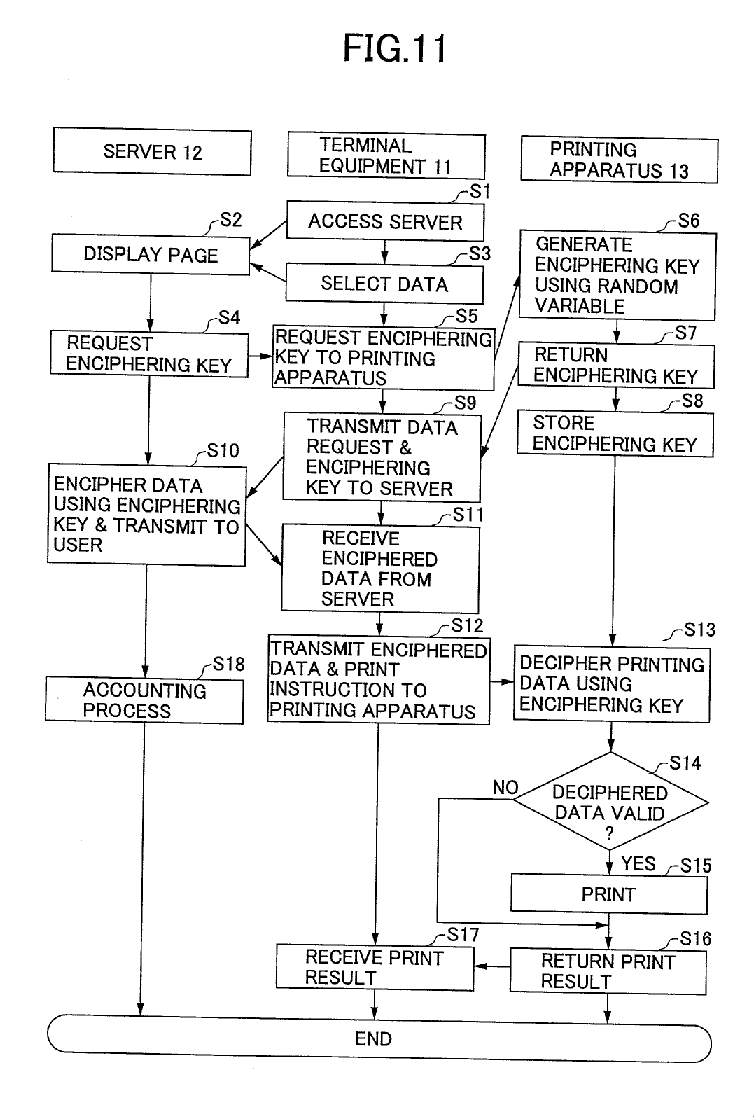

FIG. 11 is a flow chart for explaining an embodiment of the operation of this embodiment of the enciphered data processing system. In FIG. 11, steps S2, S4, S10 and S18 are carried out by the server 12, steps S1, S3, S5, S9, S11, S12 and S17 are carried out by the terminal equipment 11, and steps S6, S7, S8, S13, S14, S15 and S16 are carried out by the printing apparatus 13.

In a step S1 shown in FIG. 11, the terminal equipment 11 makes access to a home page or the like provided by the server 12. In a step S2, the server 12 transfers to the terminal equipment 11 information for displaying the accessed home page or the like on the terminal equipment 11. In a step S3, the user selects the contents (data) the user wishes to acquire from the accessed home page or the like. In a step S4, the server 12 requests an enciphering key with respect to the terminal equipment 11. In a step S5, the terminal equipment 11 transfers the enciphering key request from the server 12 to the printing apparatus 13.

In a step S6, the printing apparatus 13 generates the random variable, and generates the enciphering key based on the random variable and the machine-specified key, in response to the enciphering key request. In a step S7, the printing apparatus 13 transfers the generated enciphering key to the terminal equipment 11. In a step S8, the printing apparatus 13 stores the generated enciphering key into the storage unit 134. In a step S9, the terminal equipment 11 transfers to the server 12 the request for the contents the user wishes to acquire and the enciphering key acquired from the printing apparatus 13.

In a step S10, the server 12 enciphers the digital data and the like of the requested contents, based on the enciphering key, and transfers the enciphered digital data and the like to the terminal equipment 11. The process of the server then advances to a step S18. In a step S1, the terminal equipment 11 receives the enciphered digital data and the like, and in a step S12, the terminal equipment 11 transfers the enciphered digital data and the like to the printing apparatus 13. The process of the terminal equipment 11 then advances to a step S17 which will be described later. When printing the requested contents, the terminal equipment 11 transfers a print request together with the enciphered digital data and the like to the printing apparatus 13 in the step S12.

In a step S13, the printing apparatus 13 deciphers the enciphered digital data and the like based on the enciphering key which is stored in the storage unit 134. In a step S14, the printing apparatus 13 decides whether or not the deciphered digital data and the like are valid. If the decision result in the step S14 is NO, the process of the printing apparatus 13 advances to a step S16 which will be described later. On the other hand, if the decision result in the step S14 is YES, the printing apparatus 13 prints the enciphered original digital data and the like in a step S15, and the process of the printing apparatus 13 advances to the step S16. In the step S16, the printing apparatus 13 transfers to the terminal equipment 11 a print result which indicates information such as whether or not the printing is completed, and whether or not the deciphered digital data are valid. Thereafter, the process advances to the step S17 of the terminal equipment 11.

In the step S17, the terminal equipment 11 receives the print result from the printing apparatus 13, and the process ends. On the other hand, in the step S18, the server 12 carries out an accounting process with respect to the terminal equipment 11, for the contents which were transferred from the server 12 in response to the request from the terminal equipment 11. A timing for carrying out the accounting process is not limited to a specific timing, however, it is desirable to carry out the accounting process at a time when the enciphered digital data and the like are transferred from the server 12 to the terminal equipment 11. It is possible to carry out the accounting process at a time when the deciphering of the enciphered digital data and the like is completed in the printing apparatus 13, but in this case, it becomes necessary to send a deciphering complete notification to the server 12 at the time when the deciphering is completed. It is also possible to carry out the accounting process at a time when the printing of the deciphered digital data and the like is completed in the printing apparatus 13 or, at a time when the updating of the software or the updating of the version of the program using the deciphered digital data and the like is completed in the printing apparatus 13, but in this case, it becomes necessary to send a deciphering complete notification to the server 12 when the printing is completed or when the updating of the software or the updating of the version of the program is completed.

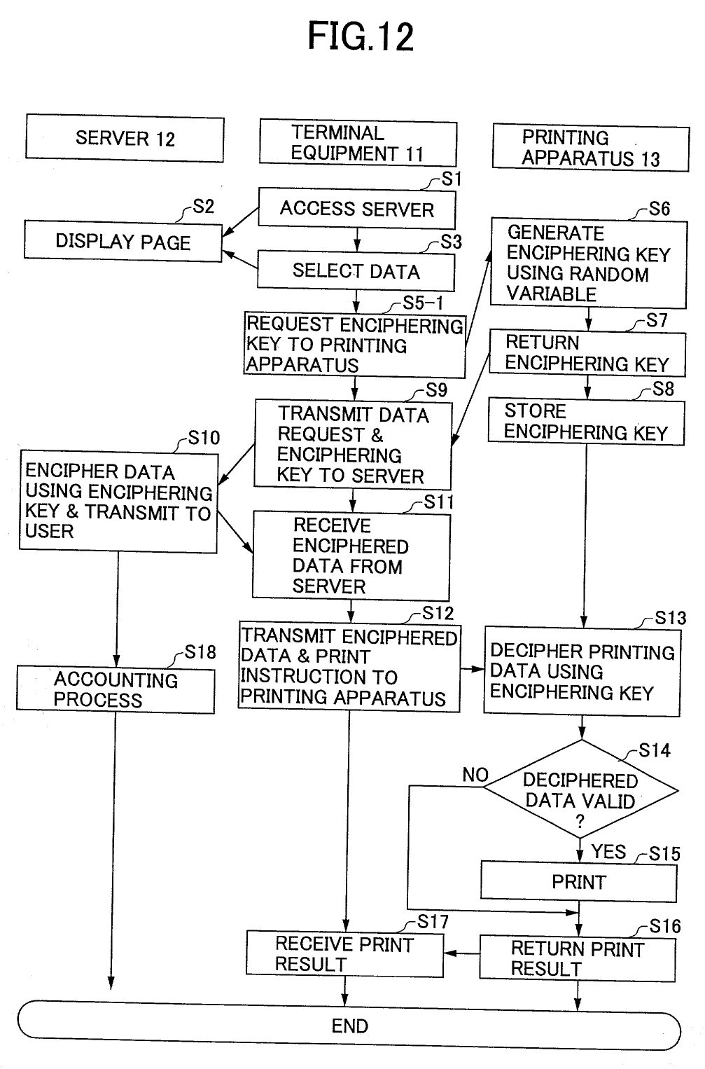

FIG. 12 is a flow chart for explaining another embodiment of the operation of the third embodiment of the enciphered data processing system. In FIG. 12, those steps which are the same as those corresponding steps in FIG. 11 are designated by the same reference numerals, and a description thereof will be omitted.

In a step S5-1 shown in FIG. 12, the terminal equipment 11 automatically requests the enciphering key with respect to the printing apparatus 13, without requiring an enciphering key request from the server 12. Hence, the server 12 does not need to carry out the step S4 shown in FIG. 11, and the process shown in FIG. 12 is simplified compared to the process shown in FIG. 11.

The operation of the first embodiment of the enciphered data processing system is basically the same as the operation shown in FIG. 11 or FIG. 12, except that it is unnecessary to carry out the steps for requesting the enciphering key from the server 12, generating the enciphering key in the printing apparatus 13, and transferring the enciphering key from the terminal equipment 11 to the server 12.

In addition, the operation of the second embodiment of the enciphered data processing system is basically the same as the operation shown in FIG. 11 or FIG. 12, except that a step for reading the enciphering key peculiar to the printing apparatus 13 from the storage unit 134 is carried out in place of the step S6 which generates the enciphering key in the printing apparatus 13.

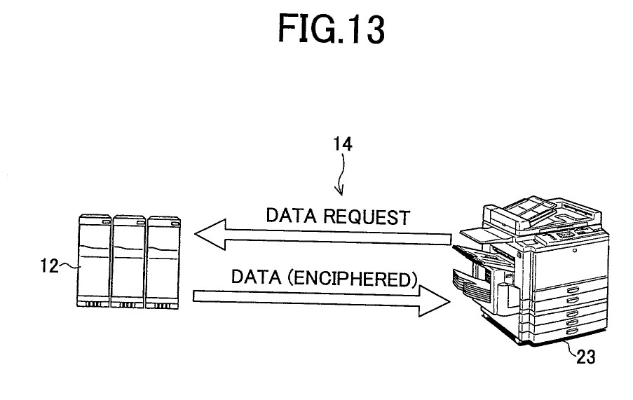

Next, a description will be given of a fourth embodiment of the image forming apparatus according to the present invention, a fourth embodiment of the enciphered data processing method according to the present invention, and a fourth embodiment of the enciphered data processing system according to the present invention. FIG. 13 is a diagram showing a digital data distribution system which is applied with the fourth embodiment of the enciphered data processing method according to the present invention. In FIG. 13, those parts which are the same as those corresponding part in FIG. 3 are designated by the same reference numerals, and a description thereof will be omitted.

The digital data distribution system shown in FIG. 13 corresponds to the fourth embodiment of the enciphered data processing system according to the present invention. The fourth embodiment of the enciphered data processing method and the fourth embodiment of the enciphered data processing system employ the fourth embodiment of the image forming apparatus according to the present invention. The composite apparatus 23 corresponds to the fourth embodiment of the image forming apparatus. This embodiment uses an enciphering key which is peculiar to the composite apparatus 23 as in the case of the second embodiment described above, but it is of course possible to use an enciphering key which is generated as in the case of the third embodiment described above. For example, a manufacturer's part number or an Internet protocol (IP) address of the composite apparatus 23 may be used as the enciphering key peculiar to the composite apparatus 23. In the following description, the enciphering key peculiar to the composite apparatus 23 will also be referred to as a machine-specified key.

In FIG. 13, the server 12 and the composite apparatus 23 are connected via the network 14, without passing via a terminal equipment. The composite apparatus 23 is a so-called multi-function apparatus which has at least one function other than a printing function, such as a copying function (including document reading function), a facsimile transmitting and receiving function, an Internet connecting function (which may include an electronic mail transmitting and receiving function), and a filing function which can file data and the like acquired via the Internet. Such a multi-function apparatus itself is known, and a detailed description thereof will be omitted in this specification. In this embodiment, the composite apparatus 23 has, in addition to the various functions described above, a function of printing various contents acquired via the Internet, and updating the software or updating the version of the program based on the various contents. This embodiment is characterized in that, the composite apparatus 23 is provided with a means for requesting the desired digital contents or the like to the server 12, receiving the requested digital contents or the like from the server 12, and deciphering the enciphered digital data and the like received from the server 12.

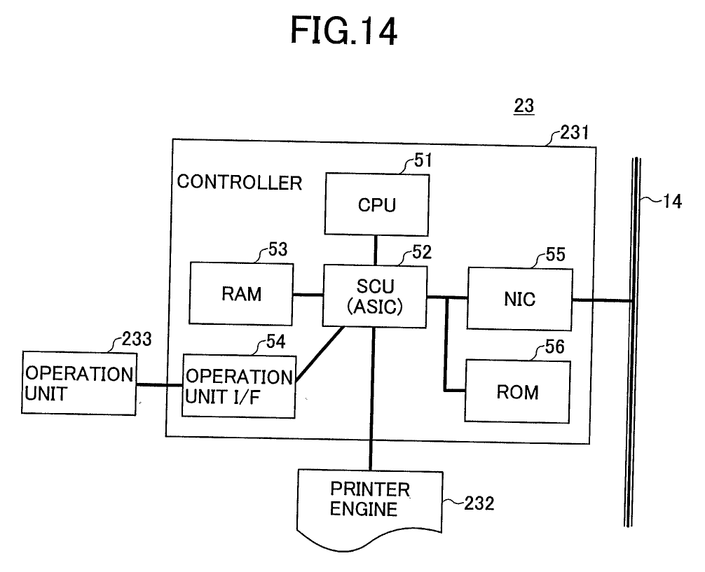

FIG. 14 is a system block diagram showing a basic structure of an important part of the composite apparatus 23. As shown in FIG. 14, the composite apparatus 23 includes a controller 231, a printer engine 232, and an operation unit 233. The controller 231 includes a CPU 51, a system control unit (SCU) 52, a RAM 53, an operation unit interface (I/F) 54, a network interface controller (NIC) 55, and a ROM 56 which are connected as shown in FIG. 14. The CPU 51 controls the general operation of the composite apparatus 23. the SCU 52 controls various parts of the composite apparatus 23, such as the printer engine 232 and a document reading unit (not shown) depending on the data and the like which are input from the operation unit 223 or obtained via the network 14, under control of the CPU 51. The RAM 53 stores various data including operation results of the CPU 51 and the data and the like obtained via the network 14. The operation unit I/F 54 provides an interface between the operation unit 233 and the controller 231. The NIC 55 controls the transmission and reception via the network 14. The ROM 56 stores programs which are executed by the CPU 51, and parameters such as an ID peculiar to the composite apparatus 23 and the IP address of the composite apparatus 23.

The operation unit 233 includes a display/operation panel, and is used to display various data and messages, and to input various instructions, data and the like. The display/operation panel may have an integral construction as in the case of a touch-panel or, may be constructed to include a display panel and an operation panel which are physically independent or, may be constructed to include a touch panel and operation buttons.

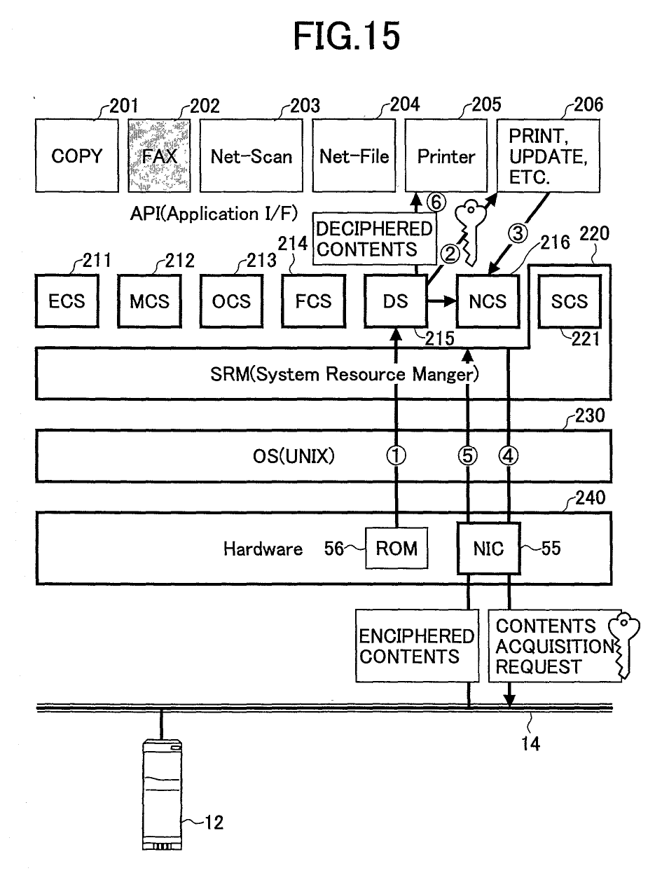

FIG. 15 is a diagram for explaining an embodiment of a software structure of the composite apparatus 23. In FIG. 15, an application (COPY) 201 indicates a copying function (including a document reading function), an application (FAX) 202 indicates a facsimile transmitting and receiving function, an application (Net-Scan) 203 indicates an Internet connecting function (which may include an electronic mail transmitting and receiving function), an application (Net-File) 204 indicates a filing function which can file data and the like acquired via the Internet, an application (Printer) 205 which indicates a printing function, and an application 206 indicates a function of printing various contents acquired via the Internet and updating the software or updating the version of the program based on the various contents. An application interface (API) includes an engine control server (ECS) 211 which controls the printer engine 232 when executing the applications 201, 202, 205 and 206, a memory control service (MCS) 212 which controls the read and write of the RAM 53 and the read of the ROM 56 when executing the applications 201 through 206, an operation panel control service (OCS) 213 which controls input and output information of the operation unit 233 when executing the applications 201 through 206, a facsimile control service (FCS) 214 which controls the facsimile transmission and reception when executing the application 202, a decipher service (DS) 215 which carries out the deciphering process when executing the application 206, and a network control service (NCS) 216 which controls the network communication when executing the applications 202 through 206.

A system resource manager (SRM) 220 manages resources such as a hardware 240 used by the services (API) 211 through 216. The SRM 220 includes an API called a system control service (SCS) 221 which manages the resources such as the hardware 240 used by the applications 201 through 206.

An operating system (OS) 230 conforms to the UNIX system in this embodiment.

The hardware 240 includes the parts shown in FIG. 14, but only the NIC 55 and the ROM 56 are shown in FIG. 15 for the sake of convenience.

A description will be given of the operation of the software and the hardware 240 shown in FIG. 15. First, as indicated by \mathring{1}, the OS 230 reads the ID peculiar to the composite apparatus 23, that is, the machine-specified key, from the ROM 56. The enciphering key is generated by the DS 215 based on the machine-specified key and stored in the RAM 53. As indicated by \mathring{2}, the enciphering key is supplied to the application 206, and as indicated by \mathring{3} and \mathring{4}, the enciphering key is transferred to the server 12 together with a contents acquisition request which requests for the desired contents, via the NCS 216, the NIC 55 and the network 14.

The server 12 enciphers the desired contents which is requested by the contents acquisition request based on a predetermined enciphering system using the enciphering key, and transfers the enciphered contents to the composite apparatus 23 via the network 14. As indicated by \mathring{5}, the enciphered contents are supplied to the DS 215 via the NIC 55 and the NCS 216. The DS 215 deciphers the enciphered contents based on the predetermined enciphering system the using the enciphering key read from the RAM 53, and the deciphered contents are printed by the application 205 as indicated by \mathring{6}.

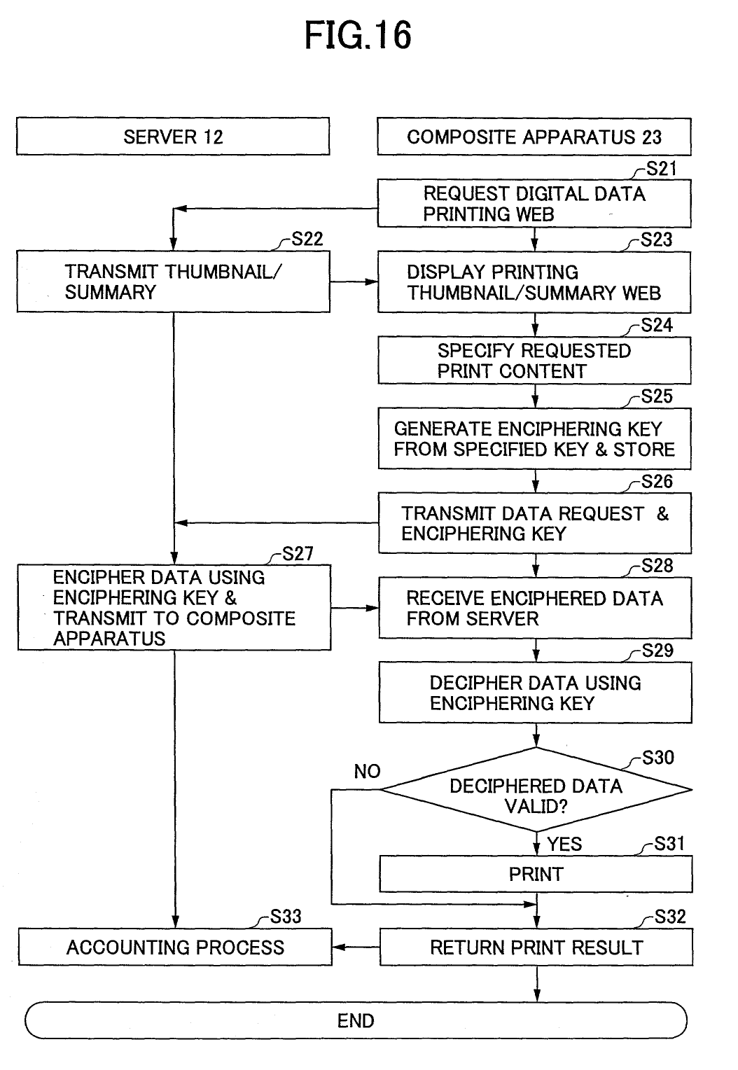

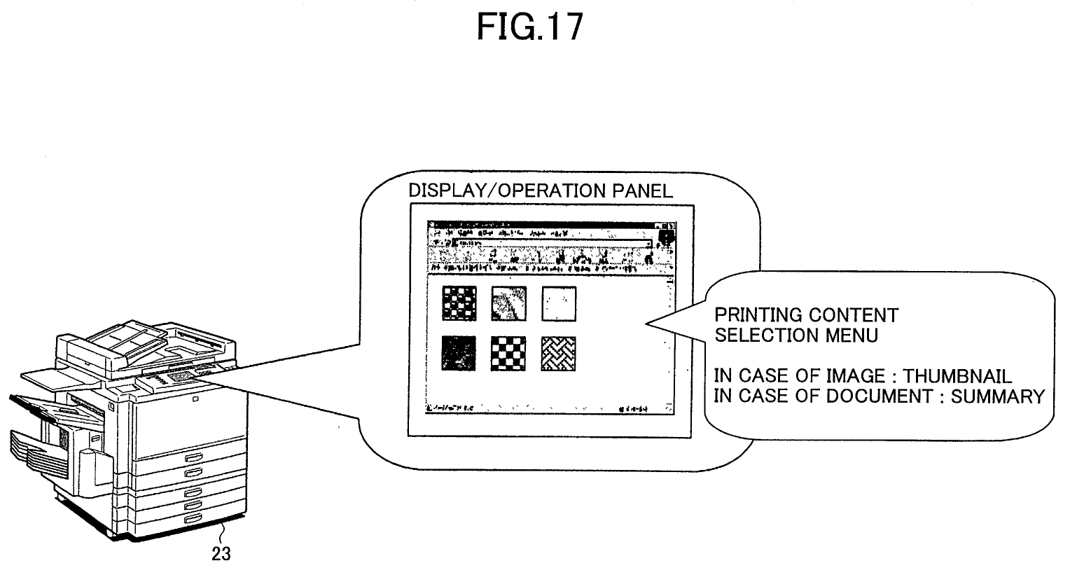

FIG. 16 is a flow chart for explaining an embodiment of the operation of the fourth embodiment of the enciphered data processing system. In addition, FIG. 17 is a diagram for explaining a menu displayed on the operation unit 233.

In a step S21 shown in FIG. 16, the composite apparatus 23 requests a digital data printing WEB to the server 12 in response to an operation of the operation unit 233 by the user. In a step S22, the server 12 transmits to the composite apparatus 23 a thumbnail in the case of an image and a summary in the case of a document. In a step S23, the composite apparatus 23 displays a printing thumbnail/summary WEB. The printing thumbnail/summary WEB is displayed on the display/operation panel of the operation unit 233 as shown in FIG. 17, for example. Because the data received by the composite apparatus 23 are enciphered and cannot be displayed, each content is displayed in the form of a thumbnail or summary. In a step S24, the user specifies a print content to be requested from the print thumbnail/summary WEB displayed on the operation unit 233. In addition, in a step S25, the composite apparatus 23 reads the machine-specified key from the ROM 56, generates the enciphering key based on the machine-specified key similarly to the third embodiment described above, for example, and stores the generated enciphering key in the RAM 53. In a step S26, the composite apparatus 23 transfers the data request and the enciphering key to the server 12.

In a step S27, the server 12 enciphers only the data of the requested print content based on the predetermined enciphering system using the enciphering key, and transfers the enciphered data to the composite apparatus 23. In a step S28, the composite apparatus 23 receives the enciphered data from the server 12. In a step S29, the composite apparatus 23 deciphers the enciphered data based on the predetermined enciphering system using the enciphering key read from the RAM 53. In a step S30, the composite apparatus 23 decides whether or not the deciphered data are valid. If the decision result in the step S30 is YES, the composite apparatus 23 prints the deciphered data by the printer engine 232 in a step S31. If the decision result in the step S30 is NO or after the step S31, the composite apparatus 23 transfers a print result to the server 12 in a step S32. In a step S33, the server 12 carries out an accounting process with respect to the composite apparatus 23 for the provided contents if the print result indicates a normal data transfer.

Therefore, in the case of the operation shown in FIG. 16, the composite apparatus 23 first receives and displays the thumbnail/summary, and the user selects the print content to be requested based on this display, so as to request the print content to the server 12. For this reason, a memory capacity of the RAM 53 used in the composite apparatus 23 can be relatively small.

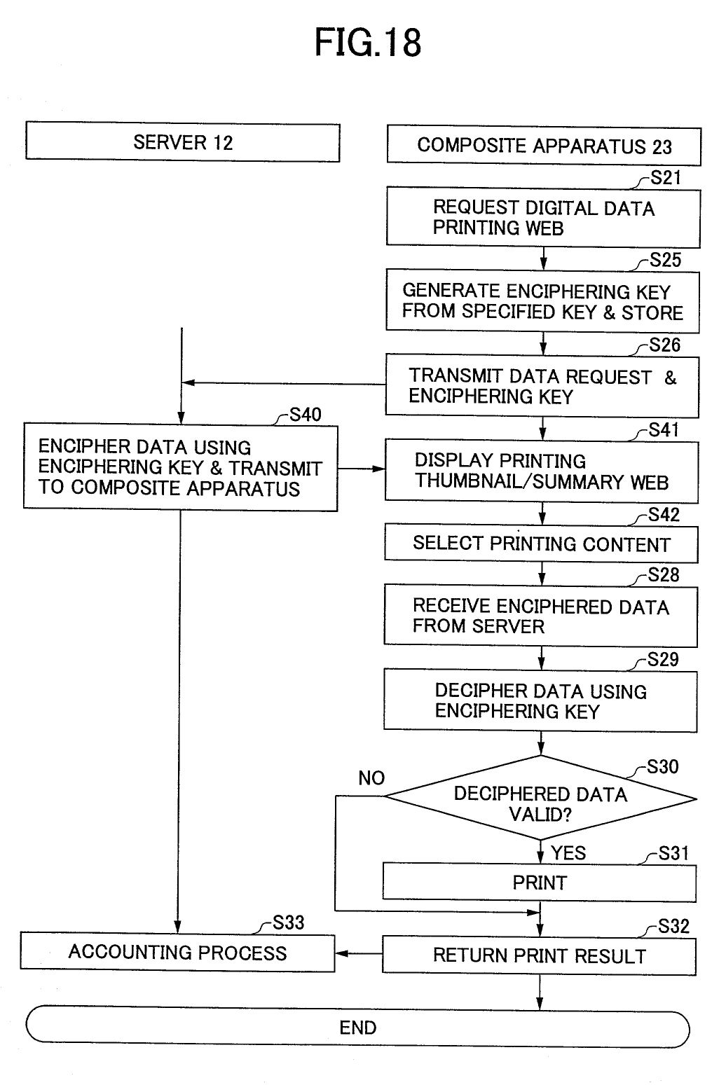

FIG. 18 is a flow chart for explaining another embodiment of the operation of the fourth embodiment of the enciphered data processing system. In FIG. 18, those steps which are the same as those corresponding steps in FIG. 16 are designated by the same reference numerals, and a description thereof will be omitted.

In FIG. 18, after the step S21, the composite apparatus 23 carries out the steps S25 and S26. On the other hand, in a step S40, the server 12 enciphers all of the requested data based on the predetermined enciphering system using the enciphering key, and transfers the enciphered data to the composite apparatus 23. In a step S41, the composite apparatus 23 displays a printing thumbnail/summary WEB on the operation unit 233. In addition, in a step S42, the user operates the operation unit 233 of the composite apparatus 23 and selects the print content.

Therefore, in the case of the operation shown in FIG. 18, all of the data are received by the composite apparatus 23 in advance and the corresponding thumbnail/summary is displayed at the composite apparatus 23. The user selects the print content from this display. For this reason, although the RAM 53 of the composite apparatus 23 requires a relatively large memory capacity, it is possible to quickly acquire the requested print content.

In the description given above, since the print content is requested, the acquired print content is printed by the printer engine 232. However, it is possible to automatically update the software or update the version of the program by the CPU 51, using a known method, based on the various requested contents which are acquired. When updating the software or updating the version of the program based on the various contents acquired from the server 12, it is possible to realize the software updating or the version updating of the program in an extremely simple manner. In either case where the printing is made or the software or program updating is made, the desired data can be acquired directly from the server 12, without requiring intervention of a terminal equipment such as a personal computer.

Further, the present invention is not limited to these embodiments, but various variations and modifications may be made without departing from the scope of the present invention.

What is claimed is:

1. An image forming apparatus comprising:
deciphering means for receiving and deciphering enciphered data; and
printing means for printing enciphered data on a recording medium.

2. The image forming apparatus as claimed in claim 1, further comprising:
request generating means for requesting the enciphered data with respect to an external server.

3. The image forming apparatus as claimed in claim 1, further comprising:
key generating means for generating an enciphering key for use in an enciphering process carried out in an external server which provides the enciphered data.

4. The image forming apparatus as claimed in claim 3, wherein said key generating means generates the enciphering key based on information peculiar to the image forming apparatus.

5. The image forming apparatus as claimed in claim 3, wherein said key generating means generates the enciphering key based on information peculiar to the image forming apparatus and a random variable.

6. An image forming apparatus comprising:
deciphering means for receiving and deciphering enciphered data;
processing means for updating software or updating a version of a program based on deciphered data; and
printing means for printing data on a recording medium.

7. The image forming apparatus as claimed in claim 6, further comprising:
request generating means for requesting the enciphered data with respect to an external server.

8. The image forming apparatus as claimed in claim 6, further comprising:
key generating means for generating an enciphering key for use in an enciphering process carried out in an external server which provides the enciphered data.

9. The image forming apparatus as claimed in claim 8, wherein said key generating means generates the enciphering key based on information peculiar to the image forming apparatus.

10. The image forming apparatus as claimed in claim 8, wherein said key generating means generates the enciphering key based on information peculiar to the image forming apparatus and a random variable.

11. An enciphered data processing method comprising:
a requesting step requesting data with respect to a server;
a transmitting step enciphering requested data in the server and transmitting enciphered data via a network;
a deciphering step receiving and deciphering the enciphered data in an apparatus which at least has a printing function; and
a printing step printing deciphered data on a recording medium in the apparatus.

12. The enciphered data processing method as claimed in claim 11, further comprising:
a request generating step requesting the enciphered data with respect to an external server.

13. The enciphered data processing method as claimed in claim 12, wherein said request generating step generates the request from a terminal equipment which is coupled to the apparatus and is capable of accessing the server.

14. The enciphered data processing method as claimed in claim 12, wherein said request generating step generates the request from the apparatus which is capable of accessing the server.

15. The enciphered data processing method as claimed in claim 11, further comprising:
a key generating step generating an enciphering key which is used by said transmitting step, in the apparatus.

16. The enciphered data processing method as claimed in claim 15, wherein said key generating step generates the enciphering key based on information peculiar to the apparatus.

17. The enciphered data processing method as claimed in claim 15, wherein said key generating step generates the enciphering key based on information peculiar to the apparatus and a random variable.

18. An enciphered data processing method comprising:
a requesting step requesting data with respect to a server;
a transmitting step enciphering requested data in the server and transmitting enciphered data via a network;
a deciphering step receiving and deciphering the enciphered data in an apparatus which at least has a printing function; and
a processing step updating software or updating a version of a program based on deciphered data.

19. The enciphered data processing method as claimed in claim 18, further comprising:
a request generating step requesting the enciphered data with respect to an external server.

20. The enciphered data processing method as claimed in claim 19, wherein said request generating step generates the request from a terminal equipment which is coupled to the apparatus and is capable of accessing the server.

21. The enciphered data processing method as claimed in claim 19, wherein said request generating step generates the request from the apparatus which is capable of accessing the server.

22. The enciphered data processing method as claimed in claim 18, further comprising:
a key generating step generating an enciphering key which is used by said transmitting step, in the apparatus.

23. The enciphered data processing method as claimed in claim 22, wherein said key generating step generates the enciphering key based on information peculiar to the apparatus.

24. The enciphered data processing method as claimed in claim 22, wherein said key generating step generates the enciphering key based on information peculiar to the apparatus and a random variable.

25. An enciphered data processing system comprising:
request means for requesting data with respect to a server;
transmitting means for enciphering requested data in the server and transmitting enciphered data via a network;
deciphering means for receiving and deciphering the enciphered data in an apparatus which at least has a printing function; and
printing means for printing deciphered data on a recording medium in the apparatus.

26. The enciphered data processing system as claimed in claim 25, wherein said requesting means is provided in a terminal equipment which is coupled to the apparatus and is capable of accessing the server.

27. The enciphered data processing system as claimed in claim 25, wherein said requesting means is provided in the apparatus which is capable of accessing the server.

28. The enciphered data processing system as claimed in claim 25, further comprising:
key generating means for generating an enciphering key which is used by said transmitting means, in the apparatus.

29. An enciphered data processing system comprising:
requesting means for requesting data with respect to a server;
transmitting means for enciphering requested data in the server and transmitting enciphered data via a network;
deciphering means for receiving and deciphering the enciphered data in an apparatus which at least has a printing function; and
processing means for updating software or updating a version of a program in the apparatus based on deciphered data.

30. The enciphered data processing system as claimed in claim 29, wherein said requesting means is provided in a terminal equipment which is coupled to the apparatus and is capable of accessing the server.

31. The enciphered data processing system as claimed in claim 29, wherein said requesting means is provided in the apparatus which is capable of accessing the server.

32. The enciphered data processing system as claimed in claim 29, further comprising:
key generating means for generating an enciphering key which is used by said transmitting means, in the apparatus.
